(19) United States
(12) Patent Application Publication
(10) Pub. No.: US 2019/0337090 A1
(43) Pub. Date: Nov. 7, 2019

(54) ELECTRONIC COMPONENT HOLDING JIG, AND METHOD FOR MANUFACTURING SAID ELECTRONIC COMPONENT HOLDING JIG

(71) Applicant: Shin-Etsu Polymer Co., Ltd., Chiyoda-ku, Tokyo (JP)

(72) Inventors: Kiyoshi HAYASHI, Kodama-gun (JP); Satoshi HOZUMI, Kodama-gun (JP)

(21) Appl. No.: 16/344,788

(22) PCT Filed: Nov. 1, 2017
(86) PCT No.: PCT/JP2017/039545

§ 371 Date: Apr. 24, 2019

(30) Foreign Application Priority Data
Nov. 9, 2016 (JP) 2016-218585

(51) Int. Cl. B23K 26/066; B23K 26/384

(52) U.S. Cl. CPC B23K 26/066; B23K 26/384

(57) ABSTRACT

Provided is a method of producing an electronic part holding jig, including applying laser light to an elastomer sheet to form a holding hole for holding an electronic part in the elastomer sheet, wherein the applying of the laser light is performed by passing the laser light emitted from a laser oscillator through a mask pattern having a transmission hole corresponding to a shape of the holding hole to be formed, and condensing the light with a lens, followed by the applying of the light to the elastomer sheet.

### RELATED APPLICATIONS

The present application is a National Phase of international Application Number PCT/JP2017/039545, filed Nov. 1, 2017, and claims priority based on Japanese Patent Application No. 2016-218585, filed Nov. 9, 2016.

### Technical Field

This disclosure relates to an electronic part holding jig configured to hold an electronic part and a method of producing the jig.

This application claims priority from Japanese Patent Application No. 2016-218585, filed on Nov. 9, 2016, the contents of which are incorporated herein by reference.

### Background Art

When a terminal electrode is mounted to a chip part, such as a ceramic capacitor, a chip resistance, or a coil, a plate-shaped holding jig configured to hold such chip part under a state in which at least one of the upper end or lower end of the part is exposed has here to fore been used. The electronic part holding jig includes a substrate having a plurality of through-holes arranged in an array. In addition, an elastic body sheet covering one surface of the substrate is formed, and holding holes having diameters smaller than those of the through-holes of the substrate are formed at the sites of the elastic body sheet corresponding to the through-holes.

The following method has been applied as a method of producing such electronic part holding jig (see Patent Literature 1). In a mold, pins having diameters smaller than those of the respective plurality of through-holes formed in the substrate are arranged in the through-holes. An uncured elastic body material liquid is poured into the mold under a state in which the pins are caused to penetrate the through-holes. The elastic body of the liquid is cured in a sheet shape, and then the pins are removed to form the holding holes.

### CITATION LIST

### Patent Literature

[PTL 1] JP 05-42123 A

### SUMMARY OF INVENTION

### Technical Problem

However, in a collective molding method involving using the mold described above, a sophisticated mold design technology is needed because such positioning that many pins are arranged in the mold with accuracy and the shrinkage of the elastic body after its curing is calculated is needed. However, the production of a mold every time the dimensions of the holding holes are changed in accordance with the shapes of many kinds of electronic parts has been a large burden in terms of time and cost.

This disclosure has been made in view of the above-mentioned circumstances, and provides a method of producing an electronic part holding jig by which a holding hole can be formed without the use of any mold, and an electronic part holding jig.

### Solution to Problem

[1] A method of producing an electronic part holding jig, including applying laser light to an elastomer sheet to form a holding hole for holding an electronic part in the elastomer sheet, wherein the applying of the laser light is performed by passing the laser light emitted from a laser oscillator through a mask pattern having a transmission hole corresponding to a shape of the holding hole to be formed, and condensing the laser light with a lens, followed by the applying of the laser light to the elastomer sheet.

[2] The method of producing an electronic part holding jig according to Item [1], wherein the elastomer sheet includes a support plate therein, wherein the support plate has arranged therein in advance a through-hole at a position corresponding to the holding hole to be formed in the elastomer sheet, wherein the laser light is applied from a first surface side of the elastomer sheet toward the through-hole of the support plate to drill a first surface of the elastomer sheet to form a first hole, wherein the laser light is applied from a second surface side of the elastomer sheet toward the through-hole of the support plate to drill a second surface of the elastomer sheet to form a second hole, and wherein the first hole and the second hole are connected in the elastomer sheet to form the holding hole penetrating the elastomer sheet.

[3] The method of producing an electronic part holding jig according to Item [2], wherein each of inner diameters of the first hole and the second hole reduces toward an inside.

[4] The method of producing an electronic part holding jig according to any one of Items [1] to [3], wherein the laser light includes a CO₂ laser, the lens includes a telecentric lens, and a number of the transmission holes of the mask pattern is two or more.

[5] The method of producing an electronic part holding jig according to any one of Items [1] to [4], further including subjecting at least one of the first surface or the second surface of the elastomer sheet to a surface treatment for reducing adhesiveness to the electronic part.

[6] An electronic part holding jig, including an elastomer sheet having formed therein a penetrating holding hole for holding an electronic part, wherein an inner diameter of the holding hole reduces from a first opening edge thereof toward an inside, and reduces from a second opening edge thereof toward the inside.

[7] The electronic part holding jig according to Item [6], wherein a surface of the elastomer sheet is subjected to a surface treatment so that adhesiveness to the electronic part reduces.

### Advantageous Effects of Invention

According to the method of producing an electronic part holding jig of this disclosure, the holding hole can be formed without the use of any mold, and hence the shape of the holding hole can be easily changed in accordance with the shapes of many kinds of electronic parts.

According to the electronic part holding jig of this disclosure, the electronic part can be stably held in the holding hole by virtue of the unique shape of the holding hole.

### BRIEF DESCRIPTION OF DRAWINGS

FIGS. 1A to 1C are each a sectional view for illustrating an example of a method of producing an electronic part holding jig according to this disclosure.

FIGS. 2A and 2B are each a sectional view for illustrating another example of the method of producing an electronic part holding jig according to this disclosure.

FIG. 3 is a schematic view for illustrating the construction of a laser processing apparatus 10.

FIG. 4A is a perspective view of an electronic part holding jig 20, FIG. 4B is a sectional view for illustrating part of a section of the electronic part holding jig 20, and FIG. 4C is a sectional view for illustrating the same section as that of FIG. 4B and for illustrating a state in which electronic parts P are held in holding holes 4.

FIG. 5 is a top view for illustrating the appearance of one of the holding holes 4 of the electronic part holding jig 20 when viewed from above.

### DESCRIPTION OF EMBODIMENTS

### Method of Producing Electronic Part Holding Jig

### (First Aspect)

A first aspect of this disclosure is a method of producing an electronic part holding jig, the method including applying laser light to an elastomer sheet to form a penetrating or non-penetrating holding hole for holding an electronic part in the elastomer sheet. The applying of the laser light is performed by a method involving passing the laser light emitted from a laser oscillator through a mask pattern having a transmission hole corresponding to the shape of the holding hole to be formed, and condensing the light with a lens, followed by the applying of the light to the elastomer sheet.

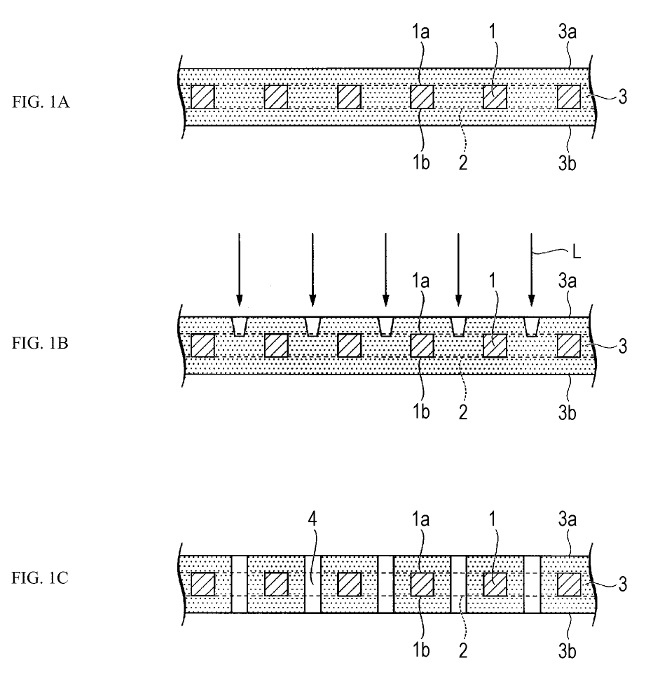

A specific example is described with reference to FIGS. 1A to 1C. First, as illustrated in a sectional view of FIG. 1A, an elastomer sheet 3 including a support plate 1 therein is prepared. In the support plate 1, a plurality of through-holes 2 penetrating the plate in its thickness direction are arranged in an array at positions corresponding to a plurality of holding holes 4 to be formed later in the elastomer sheet 3. Although the entirety of the support plate 1 is embedded in the elastomer sheet 3 in this example, part of the support plate 1, such as a second surface 1b of the support plate 1, may be exposed to the outside of the elastomer sheet 3.

A thickness from a first surface 1a of the support plate 1 to a first surface 3a of the elastomer sheet 3, and a thickness from the second surface 1b of the support plate 1 to a second surface 3b of the elastomer sheet 3 may each be independently set to, for example, from 50 μm to 2,000 μm.

A thickness from the first surface 3a to the second surface 3b of the elastomer sheet 3 may be set to, for example, from 200 μm to 5,000 μm.

The hole diameters of the through-holes 2 arranged in the support plate 1 only need to be larger than the hole diameters (inner diameters) of the holding holes 4 to be formed, and may each be set to, for example, from 50 μm to 5,000 μm. The hole diameters of the respective through-holes 2 may be identical to or different from each other.

The thickness of the support plate 1 may be set to, for example, from 100 μm to 5,000 μm.

When the support plate 1, the through-holes 2, and the elastomer sheet 3 have the above-mentioned respective dimensions, the shape of the electronic part holding jig to be formed easily becomes a shape suitable for holding an electronic part.

The kind of the elastomer of the sheet is not particularly limited as long as the holding holes 4 can be formed by laser processing, and examples thereof include: thermosetting elastomers, such as a silicone rubber and a fluororubber; thermoplastic elastomers each containing styrene, an olefin, urethane, an amide, or the like; and a vulcanized rubber. Of those, a thermosetting elastomer is preferred because the elastomer is excellent in heat resistance, chemical resistance, and dimensional stability, and a silicone rubber is more preferred.

A method of molding the elastomer sheet 3 is not particularly limited, and a known method involving forming an elastomer sheet on a substrate is applicable. For example, the elastomer sheet may be formed on one surface of the support plate 1 by: mounting the support plate 1 on a flat base; applying an elastomer composition onto the plate; and curing the elastomer composition. At this time, the elastomer composition is loaded even into the through-holes arranged in advance in the support plate 1. Subsequently, the support plate 1 on the base is inverted and mounted thereon again under a state in which the other surface is exposed, and the elastomer composition is applied to the other surface of the support plate 1, followed by the curing of the elastomer composition. Thus, a product in which the elastomer sheet 3 is formed on each of both surfaces of the support plate 1, in other words, a product in which the support plate 1 is included in the elastomer sheet 3 is obtained.

Next, laser light L shaped with a mask pattern and condensed with a lens is applied toward the first surface 3a of the elastomer sheet 3 (FIG. 1B). The laser light L is applied toward the sites of the support plate 1 where the through-holes 2 have been arranged in advance to drill the elastomer sheet 3 through thermal processing. When the laser light L drills the elastomer sheet 3 until the light penetrates the sheet, the penetrating holding hole 4 is formed at the applied site (FIG. 1C). In addition, when the drilling is stopped before the laser light L penetrates the sheet, the non-penetrating holding hole 4 is formed at the applied site.

A laser suitable for such processing is, for example, a pulse oscillation CO₂ laser or YAG laser.

A laser beam emitted from a laser oscillator is preferably subjected to primary shaping with: a mask pattern having a transmission hole for beam shaping; and one or more known optical systems selected from, for example, a fly-eye lens, a field lens, an anamorphic beam expander, a concave cylindrical lens, a convex cylindrical lens, a prism, a convex lens, and a concave lens.

The beam subjected to the primary shaping with the mask pattern and the optical system is preferably further subjected to secondary shaping by being passed through a mask pattern having a transmission hole corresponding to the shape of the opening portion of the penetrating or non-penetrating holding hole 4 to be formed in the elastomer sheet 3. Specifically, when the mask pattern includes a rectangular transmission hole, the holding hole 4 whose opening portion has a rectangular shape when viewed from above can be formed. In addition, when the mask pattern includes a circular transmission hole, the holding hole 4 whose opening portion has a circular shape when viewed from above can be formed.

The number of the transmission holes of the mask pattern may be one, or may be two or more. For example, when the mask pattern includes 4 transmission holes, 4 holding holes corresponding to the shapes of the respective transmission holes of the mask pattern may be simultaneously formed in the elastomer sheet 3 by 4 beams that have passed the respective transmission holes. Simultaneous formation of a plurality of holding holes can improve the efficiency with which the holding holes are formed.

The mask pattern (mask) is formed of a known material, such as a metal, for example, SUS or a ceramic. The transmission hole of the mask pattern may be made larger than the holding holes 4 to be formed. The beam shaped by being passed through the transmission hole of the mask pattern may be condensed with the lens to have a beam diameter smaller than the transmission hole.

In addition, in order that a beam may enter the first surface 3a of the elastomer sheet 3 in a substantially vertical manner, the beam subjected to the primary shaping or the secondary shaping with the above-mentioned optical system is preferably further passed through a telecentric lens to be caused to form an image on the first surface 3a. When the beam is caused to enter the first surface 3a in a substantially vertical manner, the taper angle of a side surface of each of the holding holes 4 can be reduced, and hence the holding hole 4 having an inner side surface substantially vertical to the first surface 3a can be formed. The term “taper angle” as used herein refers to an angle formed by the inner side surface of the holding hole 4 with respect to the vertical line of the first surface 3a. When the inner side surface of the holding hole 4 is vertical to the first surface 3a, the taper angle is 0°.

The beam diameter of the laser light L that has been passed through the mask pattern and the lens is preferably comparable to the inner diameters of the holding holes 4 to be formed. In the case of the beam diameter, the light can be applied to the entirety of the single holding hole 4 to be formed, and hence there is no need to scan the first surface with the beam at the time of the formation of the holding hole 4. Meanwhile, when the beam diameter is narrowed and the light is applied while following the contour of the holding hole 4, the first surface needs to be scanned with the beam with high accuracy, and hence the production efficiency of the electric part holding jig significantly reduces.

A desired taper angle may be imparted to an inner side surface of each of the holding holes 4 by adjusting the angle at which the beam enters the first surface 3a of the elastomer sheet 3 through the adjustment of the kind, focus, and the like of the lens. The inner diameter of the holding hole 4 may be reduced from the first surface 3a toward the second surface 3b by imparting a taper angle of, for example, from 5° to 45°. Here, the inner diameter of the holding hole 4 is the diameter of the smallest circle including the holding hole 4 when the holding hole 4 is ringed perpendicularly to the thickness direction of the elastomer sheet 3. The taper angle may be imparted to each of all the inner side surfaces of the holding hole 4, or the taper angle may be imparted to part of the inner side surfaces . For example, the taper angle may be imparted to one or more arbitrary inner side surfaces out of the 4 inner side surfaces of the holding hole 4 ringed as described above, the 4 inner side surfaces each having a rectangular sectional shape.

### (Second Aspect)

As in the first aspect, a second aspect of this disclosure is a method of producing an electronic part holding jig, the method including: preparing an elastomer sheet including therein a support plate having arranged therein in advance a through-hole at a position corresponding to the holding hole to be formed in the elastomer sheet; applying the laser light from the first surface side of the elastomer sheet toward the through-hole of the support plate to drill the first surface of the elastomer sheet to form a first hole; applying the laser light from the second surface side of the elastomer sheet toward the through-hole of the support plate to drill the second surface of the elastomer sheet to form a second hole; and connecting the first hole and the second hole in the elastomer sheet to form the holding hole serving as a target.

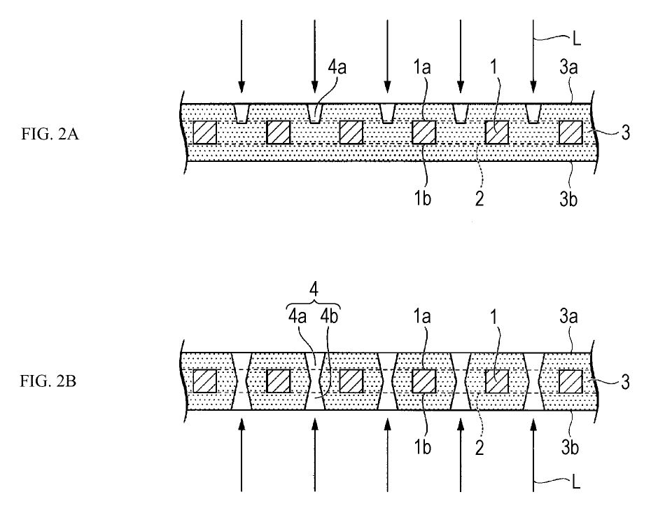

A specific example is described with reference to FIGS. 2A and 2B. First, as illustrated in FIG. 2A, the laser light L is applied from the first surface 3a side of the prepared elastomer sheet 3 toward the through-holes 2 of the support plate 1 included in the elastomer sheet 3 to drill the first surface 3a of the elastomer sheet 3 to form first holes 4a.

Further, as illustrated in FIG. 2B, the laser light L is applied from the second surface 3b side of the elastomer sheet 3 toward the through-holes 2 of the support plate 1 included in the elastomer sheet 3 to drill the second surface 3b of the elastomer sheet 3 to form second holes 4b. The penetrating holding holes 4 serving as targets are formed by advancing the drilling of the second holes 4b to couple the first holes 4a and the second holes 4b in the elastomer sheet 3.

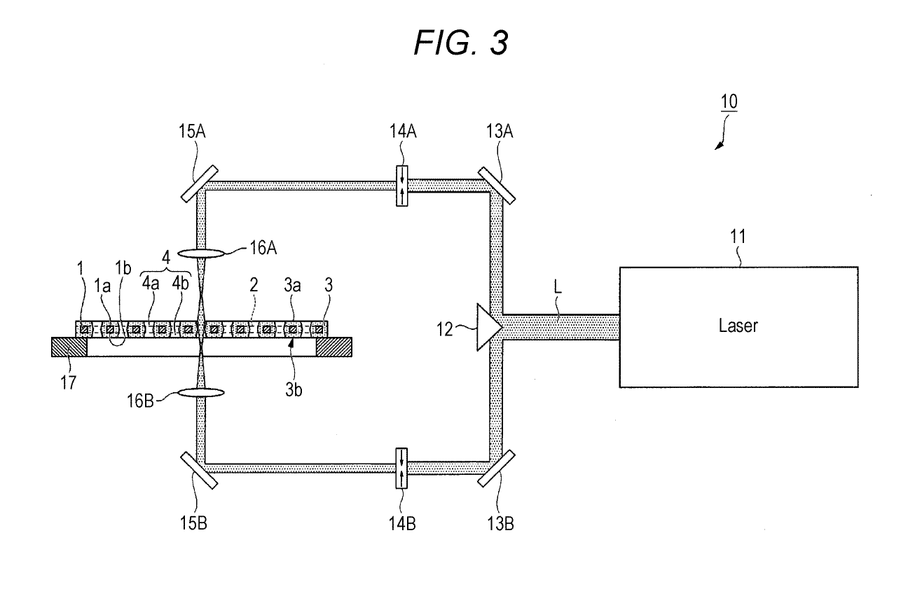

The drilling of the first surface 3a and the formation of the first holes 4a with the laser light L, and the drilling of the second surface 3b and the formation of the second holes 4b therewith may be performed simultaneously, or may be performed separately. When the former and the latter are performed separately, the second holes 4b may be formed by: stopping the applying of the laser light from the first surface 3a side before the first holes 4a become through-holes; and then applying the laser light from the second surface 3b side. When the former and the latter are performed simultaneously, the laser lights L may be simultaneously applied from both the first surface 3a and second surface 3b of the elastomer sheet 3 by using, for example, a laser processing apparatus 10 illustrated in FIG. 3.

The laser processing apparatus 10 of FIG. 3 has a laser oscillator 11, a rectangular prism mirror 12 for beam branching, first mirrors 13A and 13B, mask patterns 14A and 14B, second mirrors 15A and 15B, lenses 16A and 16B, and an X-Y stage 17.

The laser light L emitted from the laser oscillator 11 is divided into two with the rectangular prism mirror 12. The direction of a first beam is controlled with the first mirror 13A, and the beam is shaped with the mask pattern 14A. After that, the beam is directed toward the lens 16A with the second mirror 15A. Further, the beam is condensed with the lens 16A, and enters the first surface 3a of the elastomer sheet 3 arranged on the X-Y stage 17 to form the first hole 4a. Meanwhile, the direction of a second beam is controlled with the first mirror 13B, and the beam is shaped with the mask pattern 14B. After that, the beam is directed toward the lens 16B with the second mirror 15B. Further, the beam is condensed with the lens 16B, and enters the second surface 3b of the elastomer sheet 3 arranged on the X-Y stage 17 to form the second hole 4b.

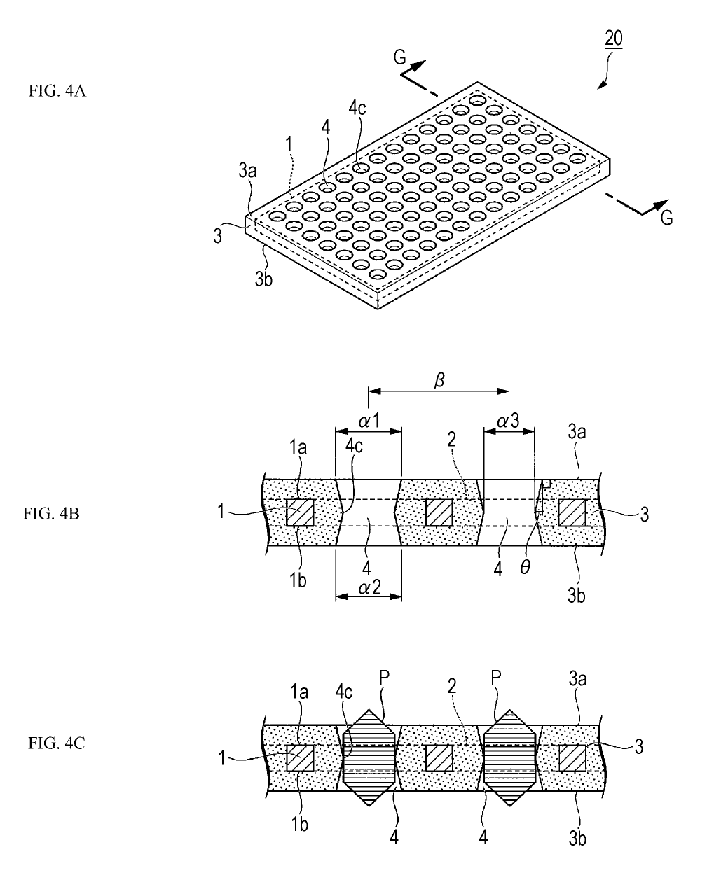

Also in the second aspect, as in the first aspect, a desired taper angle may be imparted to the inner side surface of each of the holding holes 4 by adjusting the angle at which the laser light L enters the elastomer sheet 3 through the adjustment of the kinds, focuses, and the like of the lenses. The holding hole 4 shaped like the inner hollow portion of a sandglass can be molded by reducing each of the inner diameters of the first hole 4a and the second hole 4b toward an inside to form such a shape that the inner side surface protrudes toward a central portion 4c of the holding hole 4 as illustrated in FIG. 4B.

### Action and Effect

According to the method of producing an electronic part holding jig of this disclosure described above, a holding hole can be formed with a relatively inexpensive mask pattern without the use of any expensive mold. Accordingly, a production cost for the jig reduces, and the dimensions of the holding hole can be quickly changed. In addition, the molding of the elastomer sheet and the formation of the holding hole are performed in separate steps. Accordingly, there is no risk of the shrinkage of the holding hole at the time of the molding of the elastomer sheet, and hence the holding hole can be easily formed with high accuracy.

In the method of producing an electronic part holding jig of this disclosure, the following surface treatment may be further performed. That is, at least one of the first surface 3a or second surface 3b of the elastomer sheet 3 is preferably subjected to a surface treatment for reducing adhesiveness to an electronic part P. The adhesiveness refers to tackiness inherent in the elastomer forming the elastomer sheet 3.

A specific method for the surface treatment is not particularly limited, and examples thereof include: a method involving forming a non-adhesive resin layer on the surface of the elastomer sheet 3; and a method involving forming fine irregularities on the surface of the elastomer sheet 3. The resin layer may contain a component except a resin, and may contain, for example, a filler. The resin layer may be such that the resin itself has non-adhesiveness like a fluorine-based resin, or may exhibit non-adhesiveness by containing a component except the resin, such as a filler. Irregularities derived from a filler can be formed on the surface of the resin layer containing the filler. A method involving performing blast processing in which fine particles are blown against the surface of the elastomer sheet 3 to form fine irregularities on the surface may also be given as an example thereof.

The surface treatment may be performed before the formation of the holding holes 4 in the elastomer sheet 3, or may be performed after the formation of the holding holes 4.

### Electronic Part Holding Jig

A third aspect of this disclosure is an electronic part holding jig, including an elastomer sheet having formed therein a penetrating holding hole for holding an electronic part, wherein an inner diameter of the holding hole reduces from a first opening edge thereof toward an inside, and reduces from a second opening edge thereof toward the inside. The electronic part holding jig of the third aspect can be produced by the production method of each of the first aspect and the second aspect. An example thereof is an electronic part holding jig 20 illustrated in FIGS. 4A to 4C.

As illustrated in FIG. 4A, the electronic part holding jig 20 includes: the rectangular support plate 1 measuring 20 cm by 30 cm; and the elastomer sheet 3 including the support plate 1 therein and having a volume one size larger than that of the support plate 1. The plurality of through-holes 2 (not shown) arrayed at a pitch of about 2 mm in 7 rows by 13 columns are arranged in the support plate 1. At sites where the elastomer sheet 3 covers the respective through-holes 2 of the support plate 1, the holding holes 4 having diameters one size smaller than the diameters of the through-holes 2 are formed inside the through-holes 2.

A sectional view of FIG. 4B is an illustration of part of a section taken along the line G-G of FIG. 4A. A pitch (clearance) β between the holding holes 4 adjacent to each other is about 2 mm. An inner diameter α1 of the first opening edge of each of the holding holes 4 is widest, and the diameter thereof reduces toward an inside (the thickness direction of the elastomer sheet 3). Similarly, an inner diameter α2 of the second opening edge thereof is widest, and the diameter thereof reduces toward the inside. Thus, an inner diameter α3 of the central portion 4c of the holding hole 4 becomes smallest, and hence the inner side surface of the holding hole 4 has a taper angle θ tilted with respect to the first surface 3a and second surface 3b of the elastomer sheet 3.

When each of the holding holes 4 has the above-mentioned shape, the opening portion of the holding hole 4 is relatively wide as illustrated in a sectional view of FIG. 4C. Accordingly, the electronic part P can be easily inserted there into, and the electronic part P can be reliably held in the central portion 4c that is relatively narrow. The upper end and lower end of the electronic part P held in the holding hole 4 each protrude from the elastomer sheet 3, and terminals and the like are separately mounted thereto. After that, the electronic part P is removed from the holding hole 4 and used.

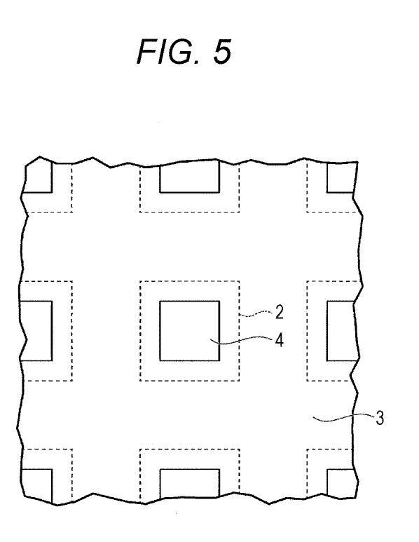

As illustrated in FIG. 5, the shape of the opening of one of the holding holes 4 when the holding hole 4 is viewed from above is appropriately set in accordance with the shape of the electronic part P, and examples thereof include shapes such as a circular shape, an elliptical shape, a rectangle, a hexagon, and any other polygon. In FIG. 5, a case in which the opening is of a quadrangular shape is illustrated.

In the example of FIG. 5, the shape of the opening of the through-hole 2 and the shape of the opening of the holding hole 4 are quadrangles, that is, are identical to each other. However, the shape of the opening of the through-hole 2 and the shape of the opening of the holding hole 4 are not required to be identical to each other, and may be different from each other.

The inner diameters of each of the holding holes 4 are appropriately adjusted in accordance with the size of the electronic part P, and the following sizes are given as examples thereof: the inner diameter α1 of the first opening edge and the inner diameter α2 of the second opening edge are each from 10 μm to 1,000 μm, and the inner diameter α3 of the central portion 4c is from 5 μm to 250 μm. Here, the inner diameter at each site of the holding hole 4 is the diameter of the smallest circle including the sectional shape of the holding hole 4 perpendicularly to the thickness direction of the elastomer sheet 3.

The length (depth) of each of the holding holes 4 is identical to the thickness of the elastomer sheet 3, and the following size is given as an example thereof: a length from the first opening edge to the second opening edge is from 500 μm to 5,000 μm.

The number and arrangement of the holding holes 4 to be arranged in the elastomer sheet 3 are not particularly limited, and an example thereof is a grid array including from 2×2=4 holes to 100×100=10,000 holes. In addition, the sizes and shapes of the respective holding holes 4 may be identical to or different from each other.

The pitch between the holding holes 4 is not particularly limited, and may be set to, for example, from about 2 mm to about 5 mm. The size of the electronic part holding jig 20 is not particularly limited, and the jig may be of, for example, a rectangular shape whose sides each have a length of from 10 cm to 30 cm.

The size of the support plate 1 is preferably such a size that the plate may be embedded in the elastomer sheet 3. In the support plate 1, the through-holes 2 are arranged at sites corresponding to the holding holes 4, and hence the through-holes 2 are arranged so as to surround the holding holes 4. In the arrangement, the through-holes 2 can support the outer peripheries of the holding holes 4, and hence the shapes of the holding holes 4 are stabilized and the insertion or removal of the electronic part P into or from each of the holding holes 4 is facilitated.

A case in which the elastomer sheet 3 is subjected to the surface treatment (treatment for making its surface non-adhesive) described in the foregoing is preferred because of the following reason: even when the electronic part P or the manipulator of the electronic part is in contact with the elastomer sheet 3 at the time of the insertion or removal of the electronic part P, the electronic part P or the manipulator hardly adheres to the surface of the elastomer sheet 3, and hence the insertion or removal of the electronic part P is further facilitated.

1. A method of producing an electronic part holding jig, comprising applying laser light to an elastomer sheet to form a holding hole for holding an electronic part in the elastomer sheet, wherein the applying of the laser light is performed by passing the laser light emitted from a laser oscillator through a mask pattern having a transmission hole corresponding to a shape of the holding hole to be formed, and condensing the laser light with a lens, followed by the applying of the laser light to the elastomer sheet.

2. The method of producing an electronic part holding jig according to claim 1,
wherein the elastomer sheet includes a support plate therein,
wherein the support plate has arranged therein in advance a through-hole at a position corresponding to the holding hole to be formed in the elastomer sheet,
wherein the laser light is applied from a first surface side of the elastomer sheet toward the through-hole of the support plate to drill a first surface of the elastomer sheet to form a first hole,
wherein the laser light is applied from a second surface side of the elastomer sheet toward the through-hole of the support plate to drill a second surface of the elastomer sheet to form a second hole, and
wherein the first hole and the second hole are connected in the elastomer sheet to form the holding hole penetrating the elastomer sheet.

3. The method of producing an electronic part holding jig according to claim 2, wherein each of inner diameters of the first hole and the second hole reduces toward an inside.

4. The method of producing an electronic part holding jig according to claim 1, wherein the laser light comprises a CO2 laser, the lens comprises a telecentric lens, and a number of the transmission holes of the mask pattern is two or more.

5. The method of producing an electronic part holding jig according to claim 1, further comprising subjecting at least one of the first surface or the second surface of the elastomer sheet to a surface treatment for reducing adhesiveness to the electronic part.

6. An electronic part holding jig, comprising an elastomer sheet having formed therein a penetrating holding hole for holding an electronic part, wherein an inner diameter of the holding hole reduces from a first opening edge thereof toward an inside, and reduces from a second opening edge thereof toward the inside.

7. The electronic part holding jig according to claim 6, wherein a surface of the elastomer sheet is processed so that adhesiveness to the electronic part reduces.
